(19) United States
(12) Patent Application Publication
(10) Pub. No.: US 2025/0147542 A1
(43) Pub. Date: May 8, 2025

(54) Edge Device Clock and Clocking Method

(71) Applicant: PARRY LABS LLC, Alexandria, VA (US)

(72) Inventor: Justin Nathaniel HUDSON, Alexandria, VA (US)

(21) Appl. No.: 18/221,272

(22) Filed: Jul. 12, 2023

(51) Int. Cl. G06F 1/04; H04B 1/715

(52) U.S. Cl. CPC G06F 1/04; H04B 1/715

(57) ABSTRACT

An edge device including software implemented in non-transitory computer-readable mediums connectable to a communication network having at least one timing element that produces a period signal that is countable, and at least one counter that counts the period signal. The at least one counter provides a first indication of time based upon the counts of the period signal and upon a triggering event, the at least one counter provides a second indication of time based upon the counts of the periodic signal wherein the second indication of time differs from first indication of time. A signal transmitted by the edge device may use time hopping with the time hopping defined in a predetermined manner or a random manner. The second indication of time may have a protocol defined in a predetermined manner or a random manner. This extra complexity enhances the security of edge devices in a network.

### FIELD OF THE INVENTION

The present invention relates generally to an edge device clock and its clocking method, and more particularly, to a smart military edge device with an improved clock and clocking method that provides improved timing and improved protection from bad actors.

### BACKGROUND

Time has been important in warfare since the advent of warfare. As technology improved, clocks were invented to increasingly keep more accurate track of time. In modern warfare time continues to be important. For example, battlefield data includes time stamps to allow data transmitted from various edge devices to be collected and integrated by an enterprise device to determine what the battlespace looks like. Keeping precise time allows disparate data sources (such as radar images) to be fused so as to be able to extract data otherwise unavailable. The importance of time is only magnified today on the modern battlefield where networking and internetworking connects nearly every system in some way. Unfortunately, the connectivity of modern battlefield also includes cyberspace where bad actors constantly try to infiltrate, destroy, disrupt, deny, and degrade communication systems setting the stage to steal or alter every kind of information defining the fabric of reality. Thus, success on the battlefield (e.g., life or death) is improved with improved timing and improved cybersecurity linked to time. Accordingly, there is a strong and continuing need to improve clock precision and to improve battlefield communications security.

### SUMMARY OF THE INVENTION

An aspect of the present invention is to provide an edge device including software implemented in non-transitory computer-readable mediums connectable to a communication network including at least one timing element that produces a period signal that is countable, and at least one counter that counts the period signal. That at least one counter provides a first indication of time based upon the counts of the period signal. Upon a triggering event, that at least one counter provides a second indication of time based upon the counts of the periodic signal, and the second indication of time differs from first indication of time.

The first indication of time may be based upon a standard time protocol. The standard time protocol is either Network Time Protocol or Precision Time Protocol. The second indication of time may have a time reference that is different than a time reference of the first indication of time. A number of bits to represent time of the first indication of time and a number of bits to represent time of the second indication of time may be the same. However, an encoding of the bits of the first indication of time and an encoding of the bits of the second indication of time may be the same or different. A number of bits to represent time of the first indication of time and a number of bits to represent time of the second indication of time may be the different. The first indication of time may be discontinued once the triggering event occurs. The first indication of time may be solely associated with synthetic data once the triggering event occurs. The first indication of time may be associated with a first type of data once the triggering event occurs while the second indication of time may be associated with a second type of data once the triggering event occurs where an importance of the first type of data is lower than an importance of the second type of data. The second indication of time may repeatedly change. A communication signal of the edge device may be time hopped by the edge device prior to transmission to the communication network. A protocol of the second indication of time may change in a predetermine manner. A protocol of the second indication of time may change in a random manner. The communication signal of the edge device may be transmitted via a frequency hopping spread spectrum. A communication signal of the edge device may be transmitted via a frequency hopping spread spectrum.

Another aspect of the present invention is to provide an edge device including software implemented in non-transitory computer-readable mediums connectable to a communication network including at least one timing element that produces a period signal that is countable, and at least one counter that counts the period signal. That at least one counter provides an indication of time based upon the counts of the period signal. A communication signal of the edge device is time hopped by the edge device prior to transmission to the communication network. A protocol of the indication of time may change in a predetermine manner or random manner. The communication signal of the edge device may be transmitted via frequency hopping spread spectrum waveforms.

Another aspect of the present invention is to provide a method of generating a time hopping signal for an edge device, including the steps of: providing an edge device that produces an edge device transmitted signal for a first length of time and an edge device transmitted signal for subsequent lengths of time, providing a first oscillator that produces a first oscillating signal, providing a first counter that counts oscillations of the first oscillating signal to produce a first measure of a real time, encoding the first measure of the real time with a first time protocol to produce first time stamps during the first length of time, generating first data sets including at least the first time stamps, encoding the first data sets to produce the edge device transmitted signal for the first length of time (the non-time hopped signal), encoding subsequent measures of the real time with subsequent time protocols to produce subsequent time stamps during the subsequent lengths of time, generating subsequent data sets including at least the subsequent time stamps, and encoding the subsequent data sets to produce the edge device transmitted signal for the subsequent lengths of time such that the subsequent data sets are not in time sequential order (the time hopped signal). The subsequent time protocols may be different than the first time protocol. The subsequent time protocols may be a plurality of different time protocols. The subsequent measures of the real time may be providing by one or more oscillators that each produce a respective oscillating signal such that at least one of the one or more oscillators produces at least one oscillating signal that is different than the first oscillating signal (preferably all are different). The edge device transmitted signal for subsequent lengths of time may be distributed across multiple frequencies (e.g., using Frequency Hopping Spread Spectrum as discussed subsequently).

### BRIEF DESCRIPTION OF THE DRAWINGS

The invention will be described in detail with reference to the following drawings in which like reference numerals refer to like elements wherein:

FIG. 1. illustrates time hopping according to the invention;

FIG. 2 illustrates one clock with different time segments;

FIG. 3 illustrates one or more clock types with different time segments (hops) and different protocols;

FIG. 4 illustrates various clocks and their respective precision; and

FIG. 5 illustrates an exemplary block structure of the present invention.

### DETAILED DESCRIPTION

Information including time is critical for current and future battlespaces. Time is currently defined by a limited number of protocols which interact with a limited number of clocks typically arrayed in ensembles that are coherently blended together and referred to as Stratums. Stratums for time are hierarchical tiers of time sources (clocks) which range from Stratum 0 to Stratum 16, with Stratum 0 being the most accurate, and Stratum 16 (and beyond) being less accurate. Network time protocols are designed to be real-time transmission capable and include some form of security. Network time protocols vary in the way that they interact with different Stratums' of clocks; however, generally speaking all global time is linked in some way from Stratum 0 time (also referred to as UTC). Example protocols which are used for network time include (but are not limited to) Network Time Protocol (NTP), Precision Time Protocol (PTP) or more obscure formats such as White Rabbit pioneered by CERN (Conseil européen pour la recherche nucléaire). Globally for networking/internetworking systems NTP is by far the most popular protocol and is a networking protocol for clock synchronization between computer systems over packet-switched, variable-latency data networks. The 64-bit binary fixed-point timestamps used by NTP consist of a 32-bit part for seconds and a 32-bit part for fractional second, giving a time scale that rolls over every 2³² seconds (136 years) and a theoretical resolution of 2⁻³² seconds (233 picoseconds). Actual resolution is limited by time source that is then transformed into NTP. NTP uses an epoch of Jan. 1, 1900.

NTPv4 introduces a 128-bit date format: 64 bits for the second and 64 bits for the fractional-second. The most-significant 32-bits of this format is the Era Number which resolves rollover ambiguity in most cases.

Over the years, security concerns have been identified in the reference implementation of the NTP codebase. For example, a missing return statement lending to otherwise prohibited access has occurred. Furthermore, NTP servers can be susceptible to man-in-the-middle attacks unless packets are cryptographically signed for authentication.

Historically, the computational overhead involved can make this impractical on busy servers, or where throughput is limited, particularly during denial-of-service attacks. This historical nuance to threat limitations tied to time is no longer applicable with the advent and proliferation of advanced high density computing systems (both classical and quantum). NTP message spoofing from a man-in-the-middle attack can be used to alter clocks on edge device computers and allow a number of attacks based on bypassing of cryptographic key expiration.

Network time coherence via NTP is key to executing Distributed Denial-of-Service attacks (DDoS) (and a variety of other time specific cyber-attacks) A small query is sent to an NTP server with the return IP address spoofed to be the target address. Similar to the DNS amplification attack, the server responds with a much larger reply that allows an attacker to substantially increase the amount of data being sent to the target.

PTP includes fewer mechanisms for authentication and encryption than NTP, making NPT more secure than PTP, which does not have the built-in security mechanisms of NTP.

PTP does not have a specific reference time like NPT but instead uses a “grandmaster clock” as a reference for time synchronization. The grandmaster clock is typically a highly accurate atomic clock or GPS receiver pegged to Stratum 0 UTC, and it provides the reference time for the entire network.

Specifically, PTP uses a hierarchical system of clocks, with the grandmaster clock at the top of the hierarchy. The grandmaster clock distributes its time information to the next level of clocks, which in turn distribute their time information to the next level of clocks, and so on. Each clock in the hierarchy adjusts its clock to match the time information received from its parent clock.

The present invention differs from NPT, PTP and other protocols (such as White Rabbit) in that there is not a single reference time but plural reference times. Furthermore, plural reference times can exist across Stratums of accuracy and not be pegged to each other in a senior/subordinate or master/slave function. Instead, there is an edge device with a timing element such as (list). The timing element is used to produce a standard clock time using NPT or PTP or the like. When a triggering event occurs, the timing element or another timing element is used to produce one or more non-standard clock times. The non-standard clock time may replace standard clock time. Alternatively, the standard clock time may keep functioning and be used to simulate data to confuse the enemy. In either case, the change in clock time from standard to non-standard fundamentally changes the function of communication between edge devices which can disrupt massively distributed denial-of-service attacks, known malware vulnerabilities and unknown malware vulnerabilities (such as zero-day's), cracked lines of communication via social engineering and physical access, rings of super-computers hosting adversarial Artificial Intelligence (A.I.), and teams of hackers conducting online attacks among other things.

Triggering events include, but are not limited to, the start of an armed conflict, start of an operation, registering an attack, or any other suitable trigger (which could include an edge device needs tied to security and quality of service).

As a result, safeguarding information from the enemy is necessarily critical as is making time as accurate as possible. This may be achieved by the identification and mitigation of bad actors at the edge according to the present invention.

The inventive edge devices may be implemented on and interconnected with existing hardware. However, the optional Chip Scale Atomic Clocks (CSAC) or other clocks may be included in new hardware or retrofitted into existing hardware.

Chip Scale Atomic Clock: Chip Scale Atomic Clocks (CSAC) 104 are used in military systems including dismounted Improvised Explosive Device (IED) jammers, dismounted Software Defined Radios (SDR), GPS receivers, and Unmanned Aerial Vehicles (UAVs). Chip Scale Atomic Clocks (CSAC) provide high precision time stamps that supports anti-spoofing, anti-networking and routing efforts, aids in improving Content Data Networking (CDN) actions (e.g., co-location according to user-sensor needs) based upon time delays due to disconnected intermittent and latent communications. Chip scale atomic clocks support multi-level security data movement tied to dynamic data movement (e.g., geolocation) to prevent ghosting of data across different classifications, domains, or otherwise. Advantageously, time delays are registered and instead of duplicate and/or stale data being rendered across the network, accurate timing tags allows smart communications systems to redact and remove redundant and/or stale data that would appear to be two separate data entities vs. the reality where those two stamps are the same but outside of time sync (termed ghosting of data).

Chip scale atomic clocks are used to create coherent geolocation of hashed entities tied to “hidden users” either inside of data flows of edge device or packet level awareness of all traffic on gateway system. Chip scale atomic clocks are key to supporting accurate mobile data archival, federation, tagging, and data retrieval across distributed meshed gateway systems. Chip scale atomic clocks support Radio Frequency (RF) front ends of decomposed edge Software Defined Radios (SDR) and sensor systems that utilize synchronized complex data exchanges over time (e.g., Orthogonal Frequency Division Multiplexing (OFDM) cellular 4G/5G networks linked to carrier aggregation and beam-forming technologies). Chip scale atomic clocks aid in identifying opposition cyber targeting actions tied to distributed attacks on gateway systems (e.g., massive denial of services tied to synchronized actions on common interfaces, ports, and protocols). Chip scale atomic clocks aid in improving traffic flow of when things are pushed or pulled to edge nodes which have very limited bandwidth (e.g., sending non-mission critical information such as streaming full motion video, out-of-date information, an routine software updates or the like over a constrained link during combat would be considered something that degrades traffic flow during peak demand times while prioritizing enemy movement information proximate to the edge node would be considered an improvement to traffic flow tied to a mission essential tasking need and essential elements of battlespace information.

A chip scale atomic clock, or alternatively any other highly accurate local timing source, that can be used to tag, optimize federation/meshing, support cross domain multi-level security classification movement to prevent ghosting of data objects across distributed areas of the battlespace, and counter adversarial adjustments tied to spoofing and time attacks.

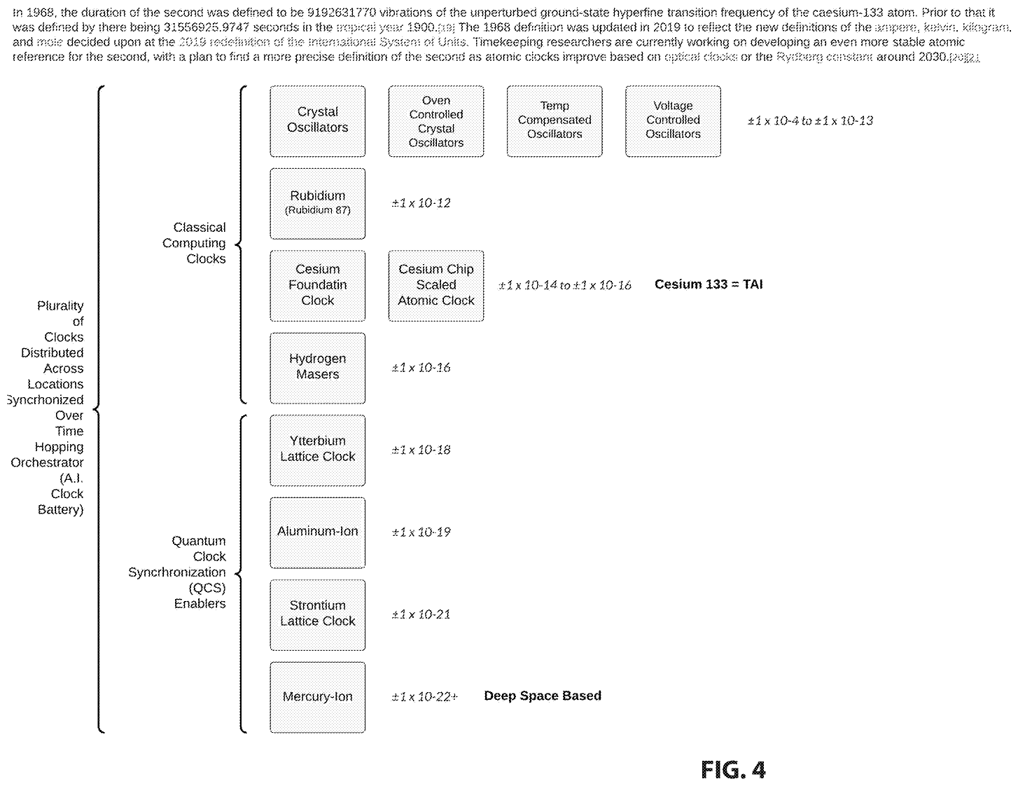

FIG. 4 illustrates various clocks and their respective precision. Cesium clocks and rubidium are often found at tactical levels of warfare (occasionally military hardware will use a quartz clock). Cesium and Hydrogen (such as in the case of NIST or Naval Observatory) clocks are usually used at operational levels to strategic levels of warfare. Any of the NIST, National Labs, Department of Energy Quantum Computing centers clocks are what would be used for strategic levels of warfare aligned with highly sensitive systems that require extremely accurate time (such as Quantum Computers).

Traditionally Stratum clocks are divided with one time source. The present invention may use multiple equivalent times/time references with time but represented differently (how time is counted from a reference clock may be different, the reference time may be different, the data structure of the representation of the time may be different, and/or there may be other differences).

Functionally creates a time a domain or time variable which may be used to better secure communication and also may be used to identify bad actors. Bad actors will take time to figure out the change from T0 (UTC) which provides improved security. If bad actors have malware or the like running on infected edge devices and those devices keep using T0 (UTC), those devices will effectively self-identify themselves by continuing to operate using T0 (UTC) whereas all good actors have moved to a different time segment (T1). As an example, Secure Socket Layer (SSL) and Transport Layer Security (TLS) certificates fundamental for online activity are based upon “time” so when “time” changes and faked certificates spoofed by a bad actor can show up with bad timestamps help to identify those certificates as fakes.

A simplistic example is an edge device connected to a network using T0 (UTC) which is spoofed to use T1 using Real Time Operating System (RTOS) code. This embodiment includes Real Time Code operating on Linux which spoofs NTP Autokey certificate, protocol transformer, protocol randomizer, then external certificate management. The plurality of elements working in unison enables Linux sub-systems to request time and the jitter allowed in NTP to function as a time spoofing buffer providing the shifting from T0 to T1. Hardware that would be supportive of the transition would have the capacity to support line-speed throughput imposing little to no latency over a variety of interfaces and outputs which hosts a high accurate time source and deterministic processor (hardware and/or software) which time stamps all data and can direct automation processes that can either begin a trigger for time transition or respond to a trigger for time transition.

Example: An aircraft is flying over water towards a large strait and hostile actions such as altered, compromised, challenged, and/or manipulated of data or the like is being attempted or is occurring to the aircraft's networks, battle management systems, tactical data links and/or otherwise. There would be adjacent to the existing network a hardware intermediary that is transparent to Network 0 on Time 0 (UTC, so N0/T0). The hardware intermediary is a new form of a cross domain guard which has extremely high throughput but different from how traditional Cross Domain Solutions (CDS) work in that it does not do “dirty word searches” or “flattens the data” or the like. Instead, a watchdog service that when activated allows data to flow over predetermined hardware connections from N0/T0 to N1/T1 on a separate device then shuts off all connections electrically and/or mechanically to N0/N1. The end result is the adversary is now operating in a domain that rapidly has no real assets, and that domain N0 becomes fundamentally a honeypot that allied operators can use to hunt down the remaining bad elements and/or actors, and shape adversarial actions. This occurs because the bad actors cannot respond to the transition from N0/T0 to N1/T1 through online connections. This advantage may be extended by having allied devices existing on N1 to start to hop from T1 to Tn to continue to stymie adversarial actions.

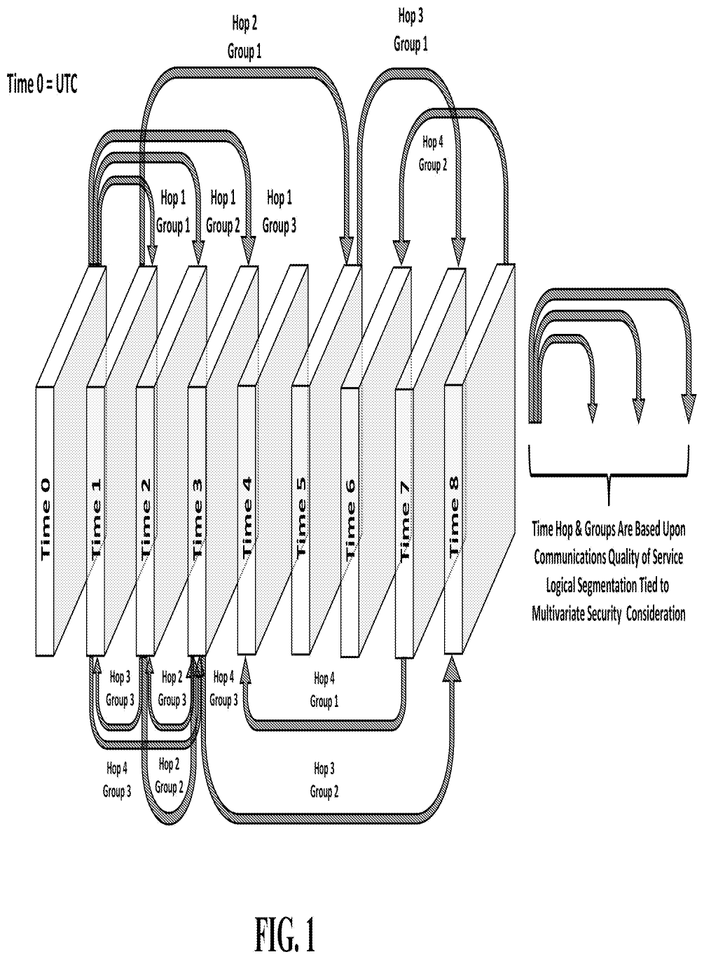

FIG. 1. illustrates time hopping according to the invention. In FIG. 1 three different Hop Groups for time are depicted. Each Hop Group has a different Quality of Service (QOS) and security posture which allows the edge devices to be optimized according to function, current topology, and edge device needs. As an example, certain systems such as those tied to Radio Frequency (RF) signal processing associated with geo-location need extremely accurate time. As such, Group 1 could be composed of different time sources that are Stratum 0 time sources which meet the time constraint requirements (e.g., clocks counting the oscillations of cesium, hydrogen, or ytterbium). Whereas Group 2 could be composed of devices that can use Stratum 0-3 time sources tied to Battle Management Systems (BMS) which operate on ARM and x86 processors distributed at the Operational (or middle environment) of warfare. Finally Group 3 could be network encoded time systems such as Tactical Data Links (TDL) like Link-16 that uses Epoch's for conveying time to Network Participation Groups (NPGs). In the setting of Group 3, hops chosen are more forgiving because there is a layer of abstraction from real time processing normally associated with systems linked to Group I (such as Electronic Warfare or Signals Intelligence systems). Hops across each group can vary in interval of relative time tied to coherence, quality of service, and security tied to edge devices. The management of the multivariate factors to include time systems that are available from a pool of diverse clocks is governed by an A.I. system. Furthermore, the complexity of the multivariate parametric details linked to edge devices, hop groups, security needs tied to protocol and purpose of hop group, and quality of service presents a new opportunity via A.I. to compose new blended times from the plurality of clocks or govern time from more accurate time sources to be “diluted” to support less accurate systems. Functionally, clocks such as Optical Lattice Clocks (OLCs) traditionally aligned with Quantum Computing efforts and traditionally using protocols such as Quantum Clock Synchronization (QCS) can be used to provide “diluted” time to common end user electronics and handheld computing systems when dilution is paired with protocol shifts.

### Time Hopping Composition and Data Flow

When composing time hopping networks each time hopping participant location broadcasts its time in real time via frequency signals with timecodes for different clocks (e.g., rubidium, cesium, hydrogen, ytterbium, and strontium clocks). Those signals are denoted by a clock identifier for time code and location (if known). For example, CES (GU) for cesium signal located at Guam, or CES (OKI). Identifiers can be further refined by unit. For example, CES (GU-16AF) 16 AF in this case identifies the 16th Air Force. These signals are not yet synchronized and formed into ensembles of different “Hop Groups”, prior to that designation these times and their self-identified location and/or derived location pulled from spatiotemporal analytics pulled from edge devices are sent to a highly provisioned “Time Master” location.

The “Time Master” takes the plurality of inputs provided and uses A.I. to create “Hop Groups” according to, for example, edge system processor needs, security constraints, computational complexity, inferred security risks, and quality of service requirements either explicitly or implicitly defined. Quality of service metrics taken into consideration may be inclusive of speed, vectors of assets, heading, rate of turns, pitch, yaw, elevation, and predictive network/spatiotemporal intelligence tied to edge device needs which includes, but is not limited to, latency, jitter, uptime and hosted algorithms, applications, and analytical processing/storage constraints of edge devices/services.

Once the A.I. time master creates “Hop Groups” it dynamically and continually assesses and adjusts hop duration, hop interval, next hop, and aligns energy of different clock signals for coherent transfers. Additionally, it manages protocol transformations for providing time to real-time operations (electronic warfare and signals intelligence systems), semi-real-time (ISR and Battle Management Systems) and to systems using epoch-based time encoded networking (such as Link-16 and those used by long range precision fires). A sub-service part of the A.I. Time Master manages the transformation of real time signal transformation of timing signals into a diverse set of protocols tied to security and quality of service. As an example, for “Hop Group 1” time may be provided via protocol steganography in the form of a Real Time Streaming Protocol (RTSP) usually used in Full Motion Video (FMV). In “Hop Group 2” time may be provided through a streaming protocol of the commercial ADS-B protocol. For “Hop Group 3” time may be provided through the streaming protocol of AIS (usually used in maritime traffic). The goal is to create ambiguity and lattice-like computational complexity for time reference signals by hiding them in plain sight to inhibit any bad actors who attempt a man-in-the-middle, packet capture or spoofing attack against the ensemble of systems operating over that hop.

Additionally, the A.I. Time Master may choose to combine multiple time sources geospatially distributed under one “Hop Group” supporting a retrospectively weighed average which forms redundancy and improves reliability of time across that ensemble operating within that “Hop Group”. The A.I. Time Master may choose to use highly accurate time sources such as Optical Lattice Clocks (OLCs) with cesium-133 clocks to improve edge devices that operate in the same locational setting and need different accuracies of time. In that case, the A.I. Time Master can either provide a blended multiplexed time that provides a median time suitable for the edge devices or provide multi-path time to different edge devices operating within the same time hop.

Time hopping errors are reconciled through the A.I. Time Master which assets which time hops should be used, when and by which edge device and device groupings. Time hopping division can occur based upon mission as well. Mission groups can be constructed similar to Link-16 Network Participation Groups (NPGs) as intentional or inferred based upon pattern of line, and communications optimization tied to content data networking.

Time is provided generally to three classes of systems: edge devices, gateway/internetworking systems, and cloud systems.

Initial time transition from Time Zero (T0) representing UTC to T1 occurs on edge system through an event trigger either on the edge device based upon predetermined or inferred criteria on the system or externally via a trusted source. After the initial time hop the spoofing system continues to respond to triggers to support each successive hop. Initial transition from a gateway device/cloud functioning as an network/internetworking junction point operates in a similar way in that time shifts occur via a trigger event; however, the method of maintaining oscillation can vary from having hosted real time code supporting hops to hosting a Virtual Private Network (VPN) certificate connected to a deterministic processor which directs traffic orchestration to a non-routable network-object hosted in private IP space and functioning as the A.I. Time master.

In the most secure implementation of time hopping the A.I. Time Master is hosted in private IP space, sometimes on a public network, and is represented to edge devices as a non-routable network-object which resolves/directs hops. This design is important because it allows ensembles of clocks that drift away from the time hopping network (become asynchronous) for whatever reason (e.g., jamming, enemy actions) to rejoin the network via a strongly encrypted (Post Quantum Cryptographic key) Managed Attribution Network. This dedicated time pulse network can be hosted as an intranet on the internet; as well as, an intranet within private or government networks. Functionally to both the traffic of T1-Tn will look like to entities on T0 as noise and not registered by packet captures or even to Internet Exchange Point (IXP) global NetFlow analysis. Instead, the only thing that will be registered in photonic counting of energy traversing global lines of communications.

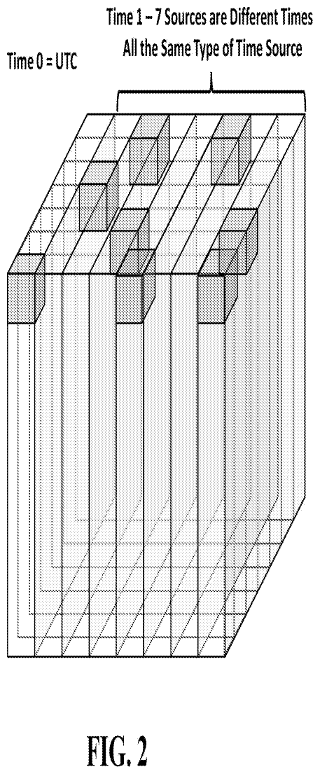

FIG. 2 illustrates one clock with different time segments. For example, a blended Cesium 133 over a different relative time hops are denoted as squares. A cipher for hops may use a simple A.I. for auto-generating hop groups according to device specific quality of service paired with security considerations. In this model the A.I. system in it of itself is the cipher which fluidly defines hops based upon the plurality of clocks available, the compatibility of clocks to be blended, and protocols aligned with edge device requirements across the Open Systems Interconnection (OSI) protocol stack.

Bad actors do not always have full awareness of network architectures dedicated for purpose-built systems which are often found across government environments (e.g., C2, Nuclear, ISR, SI/EW) to be subverted. However, bad actors do know that their lack of persistent network intelligence can be mitigated by attacking fulcrum points of the architecture. Fulcrum points often arise and correspond because commercial best practices are routinely adopted into networks. Those commercial best practices are formed around repeatable network designs that align with commercial scalability needs and growth. Network Time being delivered in the form of NPT or PTP is a fulcrum point. For example, every current architecture across the world but in particular every nation to include the United States Department of Defense (DoD) and Intelligence Community (IC) is based off synchronization with UTC. UTC is composed of TAI (also known as Atomic Time) which consists of hundreds of Cesium 133 clocks distributed globally as an ensemble with the median time being TAI, combined with International Earth Rotation Service (IERS, which is functionally a time leap year applied according to rotation of the earth) which adds or removes time based upon the axial rotation of earth either speeding up or slowing down. By using times other than UTC (and its subcomponents), this fulcrum point is effectively eliminated, and security is enhanced. Security may be further enhanced by implementing time-hopping. Time hopping enhances security because it may stop rings of supercomputers, bots, and hackers from accessing and operating throughout a network because the time fulcrum point has been eliminated. Time-Hopping can be further enhanced by protocol transitions to include but not be limited to full randomization via algorithms tied to quality of service and security or even security-based transitions which may or may not be tied to the formerly listed transitions linked to steganography where time is even protected through obfuscation of the stream providing time.

Time hopping may be considered by some as using time as a form of cryptography. The difference from traditional cryptography is the cipher is functionally not a traditional cipher in the form of a key but rather a series of algorithms which may be applied through deterministic or advanced Artificial Intelligence enabled processes or processing. Time hopping allows creation of a new slice of assured operational space (referred to as a domain of warfare) where bad actors are prevented from accessing such systems. Networks implementing a non-standard time or time hopping create diverse and layered computational complexity stymieing rings of super computers actions. Additionally, time hopping hardens not just individual devices from adversarial actions, but also every device attached to such a network. Functionally, it allows potentially catastrophic vulnerabilities that are both known and unknown on the network without the threat tied to online actions from ever being realized due to that system operating in a different time space segment that the bad actors. By initiating non-standard times or time hopping at times of high importance (e.g., the start of an attack), networks may be made opaque, effectively creating enterprise wide digital camouflage, harden our devices, and creates an environment where bad actors are placed at a disadvantage because they do not control the tempo and decision advantage enabling friendly force offset advantage. For example, a triggering event (e.g., armed conflict begins) occurs and non-standard time begins. Bad actors initiate cyber warfare. One thing that may be done is denial-of-service attacks. Since time has changed, the required cohesiveness required for a denial-of-service attack may no longer exist, communications using non-standard time may prevent bad actors from communicating with infected edge devices, and bad actors using standard time may reveal themselves. Thus, the bad actors may not only fail to achieve surprise but may be surprised themselves.

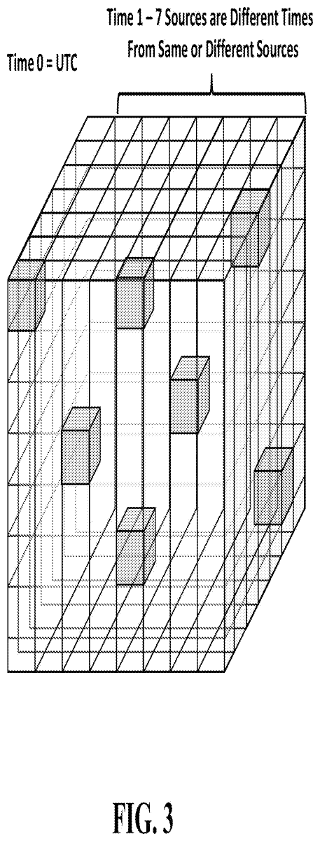

FIG. 3 illustrates one or more clock types with different time segments (hops) and different protocols. Different protocols may be used to enhance security and quality of service to deliver time over different hops. Protocol obfuscation is functionally a form of steganography.

The present invention may also be combined with other techniques. For example, a communication scheme known as “Frequency Hopping Spread Spectrum” (FHSS). In FHSS, the transmission of data occurs by rapidly switching frequencies in a predetermined pattern. The idea behind frequency hopping is to distribute the transmitted signal across multiple frequencies, making it more resistant to interference, jamming, and eavesdropping.

In FHSS, the frequency hopping pattern is synchronized between the transmitter and receiver based on a shared timing mechanism. The timing mechanism determines the duration spent on each frequency before hopping to the next. By precisely coordinating the timing, both the transmitting and receiving devices can synchronize and hop frequencies together, ensuring successful communication. FHSS can provide several benefits in computer communications, including: 1. Interference mitigation: By rapidly changing frequencies, FHSS helps to avoid interference from other devices operating in the same frequency band. This can enhance the reliability and quality of the communication; 2. Security: The dynamic frequency hopping pattern in FHSS can make it more difficult for eavesdroppers to intercept the signal and extract meaningful information. This provides a certain level of security against unauthorized access. 3. Robustness: Frequency hopping can make the communication system more resilient to intentional jamming or unintentional interference. If one frequency becomes heavily disrupted, the system can quickly switch to a different frequency, ensuring continuity of communication.

In the present invention, time hoping may be added into FHSS. By this combination, interference mitigation, security, and robustness all see a synergistic improvement (both frequency and time hopping are occurring concurrently).

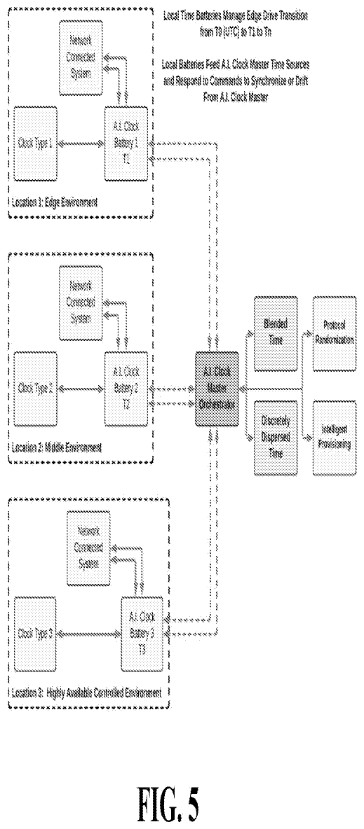

FIG. 5 illustrates an exemplary block structure of the present invention. Location 1 is the edge environment, which includes an A.I Clock Battery 1 block that communicates with a first clock type and its network connection system. Location 2 is the middle environment, which includes an A.I Clock Battery 2 block that communicates with a second clock type and its network connection system. Location 3 is the edge environment, which includes an A.I Clock Battery 3 block that communicates with a third clock type and its network connection system. The A.I Clock Battery 1, 2, 3 blocks each include an oscillator which is used to measure time. A.I Clock Battery 1 block, A.I Clock Battery 2 block, and A.I Clock Battery 3 block each communicate with an A.I. master clock orchestrator. Based on instructions from the A.I. master clock orchestrator, A.I Clock Battery 1, 2, 3 blocks select from a standard time or among one or more non-standard time, preferably multiple non-standard times. The A.I. master clock orchestrator communicates with a blended time block that (give precise description on how this blends), a discretely dispersed time block (give precise description on how this blends), a protocol randomization block that randomly selects a protocol to be used for the non-standard times or the standard time, and an intelligent provisioning block that limits protocol choices and other parameters such that if they are selected they work well with the associated network connection system.

There are several choices for time protocols for standard time for edge devices (e.g., Network Time Protocol) and these time protocols also come in various formats (e.g., DAYTIME, TIME, and NTP). Similarly, various clocks internal to edge devices operate (e.g., count) in various different ways. By varying which of these is used extra security results. A similar selection of time protocols may be made for non-standard times. Additionally, which non-standard time also needs to be selected. These selections may be made randomly for predetermined or random time intervals, could be selected according to a predetermined schedule, or any suitable combination. Where needed, an indicator of the selection could be included with the timestamps. Because the timing of the edge device may be necessary for bad actor viruses to operate successfully, the changing of the selection may inhibit bad actor viruses and may make spoofed edge devices more readily apparent. For example, a denial-of-service attack is scheduled for a particular time but because the timing is set by the wrong protocol (from the perspective of the virus), the edge device fails to do a denial-of-service attack at the correct time, effectively rendering the virus ineffective.

Commercial communication systems do not function well as military communication systems because the adversarial environment on the battlefield is fundamentally different than the commercial environment. Here, for example, the added complexity of the present invention would typically be considered a detriment to a commercial communication system despite the added security because of a number of negatives including implementation to civilian systems would be limited due to increased cost, civilian bad actors would not have access to the high-end computers also due to cost, and it would be generally viewed as excessive in a civilian communication network (cost of protection is greater than the likely damage). Conversely, in a military or intelligence setting, the bad actors have access to high-end computers, universal use is easy to mandate, and it would not be viewed as excessive in non-civilian communication networks (cost of protection is lower than the likely damage because it may be life or death).

### Definitions

Second: The current definition of the SI second is based on the (non-radioactive) caesium, 133Cs, whose atomic frequency had been fixed at 9,192,631,770 Hz in 1967.

International Atomic Time: International Atomic Time, which is also known as Temps Atomique International (TAI), is calculated by the BIPM from the readings of more than 260 atomic clocks located in metrology institutes and observatories in more than 40 countries around the world. BIPM estimates that TAI does not lose or gain with respect to an imaginary perfect clock by more than about 100 nanoseconds per year.

Coordinated Universal Time (UTC): Coordinated Universal Time (UTC) is the basis for legal time worldwide and follows TAI (see above) exactly except for an integral number of seconds, presently 33 (since 2006 Jan. 1). These leap seconds are inserted on the advice of the International Earth Rotation Service (IERS) to ensure that, on average over the years, the Sun is overhead within 0.9 seconds of 12:00:00 UTC on the meridian of Greenwich. UTC is thus the modern successor of Greenwich Mean Time, GMT, which was used when the unit of time was the mean solar day.

Epoch: Epoch signifies the beginning of an era (or event) or the reference date of a system of measurements.

Edge device: any device attached or connected to networking or internetworking device or series of devices.

Although several embodiments of the present invention and its advantages have been described in detail, it should be understood that changes, substitutions, transformations, modifications, variations, permutations, and alterations may be made therein without departing from the teachings of the present invention, the spirit and the scope of the invention being set forth by the appended claims.

What is claimed is:

1. An edge device including software implemented in non-transitory computer-readable mediums connectable to a communication network comprising:
at least one timing element that produces a period signal that is countable; and
at least one counter that counts the period signal,
wherein the at least one counter provides a first indication of time based upon the counts of the period signal,
wherein upon a triggering event, the at least one counter provides a second indication of time based upon the counts of the periodic signal, and
wherein the second indication of time differs from first indication of time.

2. The edge device of claim 1, wherein the first indication of time is based upon a standard time protocol.

3. The edge device of claim 2, wherein the standard time protocol is either Network Time Protocol or Precision Time Protocol.

4. The edge device of claim 1, wherein the second indication of time has a time reference that is different than a time reference of the first indication of time.

5. The edge device of claim 1, wherein a number of bits to represent time of the first indication of time and a number of bits to represent time of the second indication of time are the same.

6. The edge device of claim 5, wherein an encoding of the bits of the first indication of time and an encoding of the bits of the second indication of time are different.

7. The edge device of claim 1, wherein a number of bits to represent time of the first indication of time and a number of bits to represent time of the second indication of time are the different.

8. The edge device of claim 1, wherein the first indication of time is discontinued once the triggering event occurs.

9. The edge device of claim 1, wherein the first indication of time is solely associated with synthetic data once the triggering event occurs.

10. The edge device of claim 1,
wherein the first indication of time is associated with a first type of data once the triggering event occurs,
wherein the second indication of time is associated with a second type of data once the triggering event occurs, and
an importance of the first type of data is lower than an importance of the second type of data.

11. The edge device of claim 1, wherein the second indication of time repeatedly changes.

12. The edge device of claim 1, wherein a communication signal of the edge device is time hopped by the edge device prior to transmission to the communication network.

13. The edge device of claim 12, wherein a protocol of the second indication of time changes in a predetermine manner.

14. The edge device of claim 12, wherein a protocol of the second indication of time changes in a random manner.

15. The edge device of claim 12, wherein the communication signal of the edge device is transmitted via a frequency hopping spread spectrum.

16. The edge device of claim 1, wherein a communication signal of the edge device is transmitted via a frequency hopping spread spectrum.

17. An edge device including software implemented in non-transitory computer-readable mediums connectable to a communication network comprising:
at least one timing element that produces a period signal that is countable; and
at least one counter that counts the period signal,
wherein the at least one counter provides an indication of time based upon the counts of the period signal,
wherein a communication signal of the edge device is time hopped by the edge device prior to transmission to the communication network.

18. The edge device of claim 17, wherein a protocol of the indication of time changes in a predetermine manner.

19. The edge device of claim 17, wherein a protocol of the indication of time changes in a random manner.

20. The edge device of claim 17, wherein the communication signal of the edge device is transmitted via a frequency hopping spread spectrum.
